(19) United States
(12) Patent Application Publication
(10) Pub. No.: US 2003/0062818 A1
(43) Pub. Date: Apr. 3, 2003

(54) Cathode-ray tube device

(75) Inventor: Kazuhiro Sugimoto, Ibaraki-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/262,448

(22) Filed: Sep. 30, 2002

(30) Foreign Application Priority Data
Oct. 1, 2001 (JP) 2001-305662

(51) Int. Cl. H01J 29/76

(52) U.S. Cl. 313/440

(57) ABSTRACT

A horizontal deflection coil is formed by winding conductive wires. A wire density of the conductive wires in a first portion of the horizontal deflection coil, which is defined in a predetermined angle range centering on a winding angle, and which is set to be θ1 with respect to a horizontal direction as 0° in an electron-gun-side region, θ2 with respect to a horizontal direction as 0° in a middle region, and θ3 with respect to a horizontal direction as 0° in a screen-side region on a cross section perpendicular to a tube axis, is smaller than a wire density of the conductive wires in a portion of the horizontal deflection coil other than the first portion. The winding angles θ1, θ2, and θ3 in the first portion satisfy θ1≧θ2≧θ3. With this configuration, it is possible to provide a cathode-ray tube device in which, without an additional correcting coil or a specific correcting circuit for generating a correcting current, the dynamic convergence adjustment is facilitated, and an excellent convergence characteristic is achieved.

### BACKGROUND OF THE INVENTION

1. Field of the Invention

The present invention relates to a cathode-ray tube device, particularly to a cathode-ray tube device in which a convergence characteristic of a deflection yoke is improved.

2. Related Background Art

As the multi-window environment such as WINDOWS by Microsoft has been used widely as an operating system for personal computers, to achieve a high resolution in a peripheral portion of a screen has been an important technological issue for cathode-ray tube devices for use as display monitors of computers.

One of the factors determining the resolution is a convergence characteristic indicating an aberration error (hereinafter referred to as “misconvergence”) of blue-, green-, and red-light-emitting electron beams on a screen.

As for a cathode-ray tube device for use in a display monitor, the misconvergence thereof on a screen is adjusted to a level of approximately 0.25 mm in the manufacturing process. Here, as is widely known, the correction of a misconvergence particularly in a corner portion of a screen between the blue-light-emitting electron beam and the red-light-emitting electron beam is relatively easy, whereas the correction of a misconvergence between the green-light-emitting electron beam and the blue-light-emitting electron beam or between the green-light-emitting electron beam and the red-light-emitting electron beam (hereinafter referred to as “green misconvergence”) is difficult.

This is because a characteristic of a soft magnetic piece made of a ferrite-powder-containing resin has a very low adjustment sensitivity to the green misconvergence. The soft magnetic piece is made of a ferrite-powder-containing resin and attached to an end of a long rectangular flat resin plate and inserted through a screen-side opening of a deflection yoke when a convergence at a corner portion of the screen (hereinafter referred to as “dynamic convergence”) is adjusted. Therefore, to obtain a good convergence characteristic, it is necessary to design the device beforehand so that the green misconvergence in the corner portion of the screen is decreased. A state in which the green convergence is deviated outward at four corner portions of a screen is called HGB, and the prior art for correcting the HGB is described below.

In a conventional deflection yoke for a cathode-ray tube device, as disclosed in JP 3053841B, an additional pair of correcting coils (sub coils) 23 and 24 for exclusive correction use is provided on an electron gun side of a deflection yoke 20 (FIG. 21 of the reference). Further, a vertical deflection circuit (not shown) is caused to generate a full-wave rectified current to vary a magnetic flux of a magnetic coil (not shown). By so doing, a current is generated in a coil connected to the correcting coils 23 and 24, so that the current flows through the correcting coils 23 and 24. This causes a specific magnetic field to be generated in the correcting coils 23 and 24, with which the HGB is corrected.

However, the above-described conventional technique has a problem that the correcting coils 23 and 24 are installed additionally only for the exclusive purpose of correcting the HGB. Besides, there is also a problem that a circuit for generating a correction current as described above has to be added in an auxiliary circuit in the deflection yoke. Since it is presumed that such addition of elements increases a circuit loss as well as increases the production cost significantly, the difficulty of designing of the deflection yoke, the cathode-ray tube, etc. also increases.

Furthermore, a degree of the improvement of the HGB by the foregoing function depends on an amount of current flowing through the circuit, while an increase in a horizontal deflection power or the circuit loss has to be minimized. Therefore, it cannot be said that sufficient correction of the HGB pattern is achieved as a result.

### SUMMARY OF THE INVENTION

Therefore, with the foregoing in mind, it is an object of the present invention to provide a cathode-ray tube device in which without an additional correcting coil or a specific correcting circuit for generating a correcting current, the dynamic convergence adjustment is facilitated, and an excellent convergence characteristic is achieved.

To achieve the foregoing object, a cathode-ray tube device of the present invention includes a cathode-ray tube having a glass panel, and a glass funnel behind the glass panel, which is connected to the glass panel, an electron gun provided in a rear part of the cathode-ray tube, and a deflection yoke including a horizontal deflection coil arranged on a circumferential surface of the rear part of the cathode-ray tube, a vertical deflection coil provided on an outer side of the horizontal deflection coil, and a ferrite core. In the cathode-ray tube device, the horizontal deflection coil is formed by winding conductive wires. Further, a wire density of the conductive wires in a first portion of the horizontal deflection coil, which is defined in a predetermined angle range centering on a winding angle with respect to a horizontal direction as 0° on a cross section perpendicular to a tube axis, is smaller than a wire density of the conductive wires in a second portion of the horizontal deflection coil that is a portion of the horizontal deflection coil other than the first portion. The winding angle is set to be θ1 with respect to a horizontal direction as 0° in a first region extending to an end position of the horizontal deflection coil on an electron gun side from a first intermediate point between the end position on the electron gun side and a position at which a horizontal magnetic field has a maximum strength. The winding angle is set to be θ2 with respect to a horizontal direction as 0° in a second region extending from the first intermediate point to a second intermediate point between an end position of the horizontal deflection coil on a screen side and the position at which a horizontal magnetic field has a maximum strength. The winding angle is set to be θ3 with respect to a horizontal direction as 0° in a third region extending from the second intermediate point to the end position of the horizontal deflection coil on the screen side, and θ1, θ2, and θ3 satisfy θ1≧θ2≧θ3.

This configuration enables the HGB control with only a horizontal coil magnetic field, and the efficient reduction of HGB, thereby facilitating the dynamic convergence adjustment. As a result, it is possible to obtain a cathode-ray tube device having an excellent convergence characteristic.

Besides, the same effect can be expected with a cathode-ray tube device having the same configuration further arranged so that at least two of the first, second, and third regions include a first portion, which is defined in a predetermined angle range centering on a winding angle with respect to a horizontal direction as 0° on a cross section of the horizontal deflection coil perpendicular to a tube axis, and a winding angle of the first portion in one of the two regions on the electron gun side is greater than a winding angle of the first portion in the other region on the screen side.

Furthermore, the same effect can be expected with a cathode-ray tube device having the same configuration further arranged so that at least one of the first, second, and third regions includes a first portion defined in a predetermined angle range centering on a winding angle with respect to a horizontal direction as 0° on a cross section of the horizontal deflection coil perpendicular to a tube axis.

Furthermore, in the cathode-ray tube device according to the present invention, it is preferable that the predetermined angle range is an angle range of ±2° centering on the winding angle.

Furthermore, in the cathode-ray tube device according to the present invention, it is preferable that a recess is formed in the first portion of the horizontal deflection coil.

Furthermore, in the cathode-ray tube device according to the present invention, it is preferable that the first portion of the horizontal deflection coil has a thickness of less than 40% of a maximum thickness of the horizontal deflection coil.

Furthermore, in the cathode-ray tube device according to the present invention, it is preferable that the winding angle θ1 satisfies 35°≦θ1≦65°, the winding angle θ2 satisfies 25°≦θ2≦55°, and the winding angle θ3 satisfies 15≦θ3≦45°.

### BRIEF DESCRIPTION OF THE DRAWINGS

FIG. 1 is a plan view of a cathode-ray tube device according to an embodiment of the present invention.

FIG. 2 is a view of only a horizontal deflection coil in the cathode-ray tube device according to the embodiment of the present invention, viewed from blow.

FIG. 3 is a vertical cross-sectional view of the horizontal deflection coil in the cathode-ray tube device according to the embodiment of the present invention.

FIG. 4 is an explanatory view illustrating an HGB pattern.

FIG. 5 is an explanatory view illustrating a beam arrangement and a horizontal deflection magnetic field in an electron-gun-side region.

FIG. 6 is an explanatory view of a preliminary vertical deflection (upon upward deflection).

FIG. 7 is an explanatory view of an electron beam path.

FIGS. 8A and 8B are views of a perpendicular magnetic field distribution in a deflection yoke.

FIG. 9 is an explanatory view of an HGB pattern after correction.

FIG. 10 is an explanatory view illustrating a beam arrangement and a horizontal deflection magnetic field in a middle region.

FIG. 11 is an explanatory view of a beam arrangement and a horizontal deflection magnetic field in a screen-side region.

FIG. 12 is a graph of an HGB variance in the case where a horizontal deflection coil having a three-dimensional portion is used in the cathode-ray tube device according to the present embodiment.

FIG. 13 is a view illustrating a relationship between a thickness ratio substantially in the diameter direction and a value of correction of a misconvergence HGB.

FIG. 14 is a view illustrating a HGB correction effect in the case where a horizontal deflection coil having a three-dimensional portion is used in the cathode-ray tube device according to the present embodiment.

FIG. 15 is a perspective view of a deflection yoke and vicinities thereof in a conventional cathode-ray tube device.

### DETAILED DESCRIPTION OF THE INVENTION

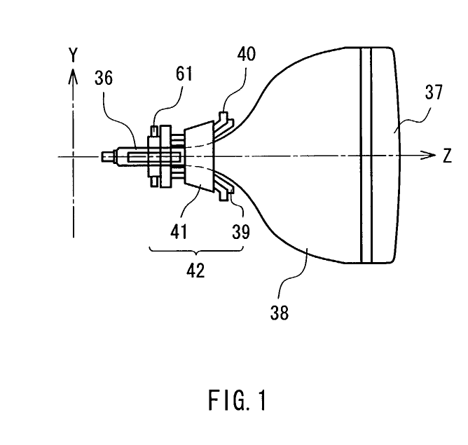

The following will describe a cathode-ray tube device according to an embodiment of the present invention, while referring to the drawings. FIG. 1 is a plan view of a cathode-ray tube device according to an embodiment of the present invention.

In FIG. 1, a cathode-ray tube 36 is composed of a glass panel 37 and a glass funnel 38 connected to a rear part of the glass panel 37. An electron gun is provided in the rear part of the cathode-ray tube 36. Besides, on a circumferential surface of the rear part of the cathode-ray tube 36, there is provided a deflection yoke 42 that is composed of a horizontal deflection coil 39 wound in a saddle form, a saddle-form vertical deflection coil 40 provided on an outer side of the horizontal deflection coil 39, and a ferrite core 41 provided on an outer side of the vertical deflection coil 40.

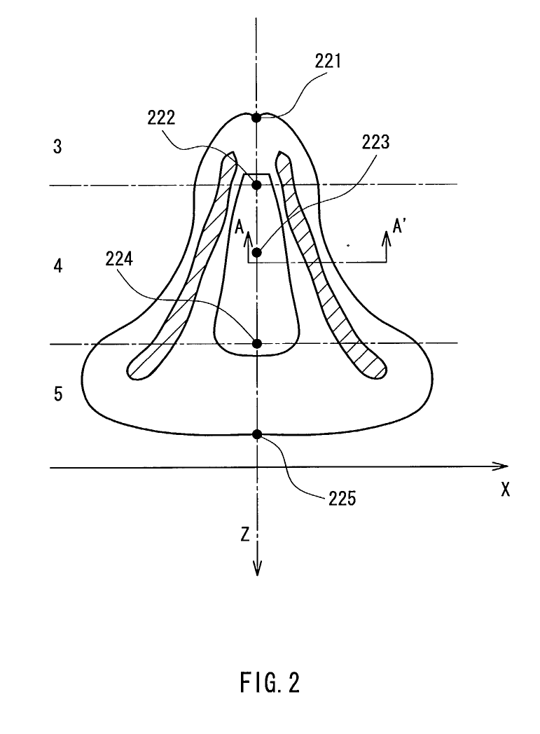

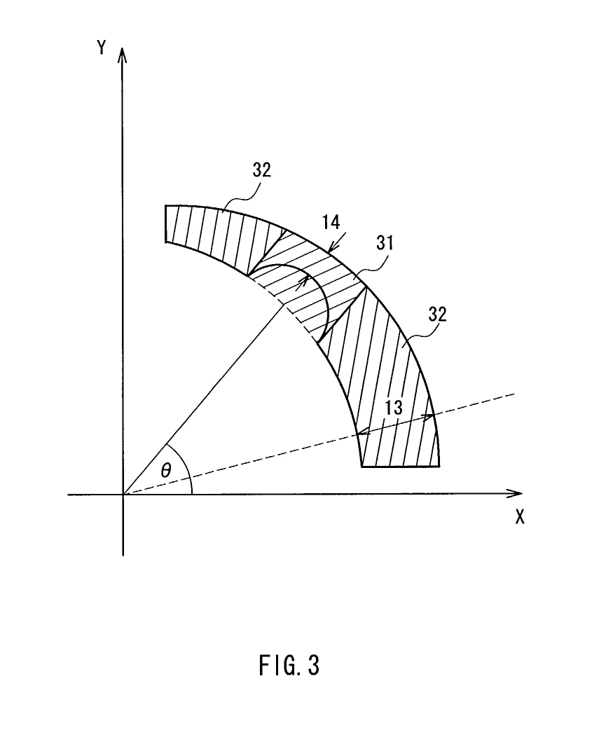

FIG. 2 is a view of only the horizontal deflection coil 39 viewed from below, which is a simplified view in which the illustration of each coil wire is omitted. FIG. 3 is a vertical cross-sectional view of the horizontal deflection coil 39 shown in FIG. 2, which is taken along a line A-A′. In FIG. 3, the horizontal deflection coil 39 is shown as a region defined by an envelope of the coil wires located at outermost positions (hereinafter referred to as “housing”), with a winding angle θ being defined as an angle ranging from the horizontal axis (x axis), which is assumed to be 0°, toward the vertical axis (y axis). It should be noted that the housing is equivalent to a shape of a mold that is used for forming the horizontal deflection coil by winding a coil wire.

More specifically, the shape of the horizontal deflection coil 39 in the cathode-ray tube device according to the present embodiment is, as shown in FIG. 2, a saddle-like shape obtained by dividing a conic shape into half. This conic shape is formed according to the funnel cone shape in a direction (in a positive z direction) from a region 3, to a region 4, and then, to a region 5. The region 3 extends from an intermediate point 222 to an end position 221 of the horizontal deflection coil on the electron gun side, the intermediate point 222 being an intermediate point between the end position 221 and a position 223 at which a horizontal magnetic field has a maximum strength (this region 3 is hereinafter referred to as “electron-gun-side region”). The region 4 extends from the intermediate point 222 to an intermediate point 224 between an end position 225 of the horizontal deflection coil on the screen side and the position 223 (this region 4 is hereinafter referred to as “middle region”). The region 5 extends from the intermediate point 224 to the end position 225 (this region 5 is hereinafter referred to as “screen-side region”).

Then, as shown in FIG. 3, a wire density of conductive wires in a first portion 31 in a predetermined angle range centering on the winding angle θ (indicated by hatching with slashes) is smaller than a wire density of conductive wires in a second portion 32 of the housing other than the first portion 31 (indicated by hatching with back-slashes). The configuration in which the wire density in the first portion 31 is smaller than the wire density in the second portion 32 can be achieved by, for instance, forming a recess in a portion of the horizontal deflection coil (hereinafter referred to as “three-dimensional-shaped portion”). Here, the wire density is defined as a rate of areas of cross sections of wires per a unit area of a cross section of the deflection coil taken along a plane containing the tube axis (the Z axis).

Furthermore, the first portion 31 having the smaller wire density of conductive wires than that in the second portion 32 is provided in a range of a winding angle θ1 satisfying 35°≦θ1≦65° in the electron-gun-side region 3, a range of a winding angle θ2 satisfying 25°≦θ2≦55° in the middle region 4, and a range of a winding angle θ3 satisfying 15°≦θ3≦45° in the screen-side region 5. In other words, the recess provided in the electron-gun-side region 3, the middle region 4, and the screen-side region 5 is characterized in that the winding gradually changes from the electron-gun-side region through the middle region 4 to the screen-side region 5.

The foregoing three-dimensional-shaped portion is characterized in that, viewing a vertical cross section of the horizontal deflection coil in the cathode-ray tube device according to the embodiment of the present invention as in FIG. 3, a portion of the housing in a concentric cell defined by concentric circles and lines tilted at angles of ±2° with respect to the winding angle θ has a minimum thickness 14, which is taken substantially in a diameter direction of the horizontal deflection coil on a cross section perpendicular to the tube axis (a diameter direction in an approximate circular shape centering on the tube axis), of less than 40% of a maximum thickness 13 taken substantially in the diameter direction of the horizontal deflection coil on a cross section perpendicular to the tube axis shown in FIG. 3.

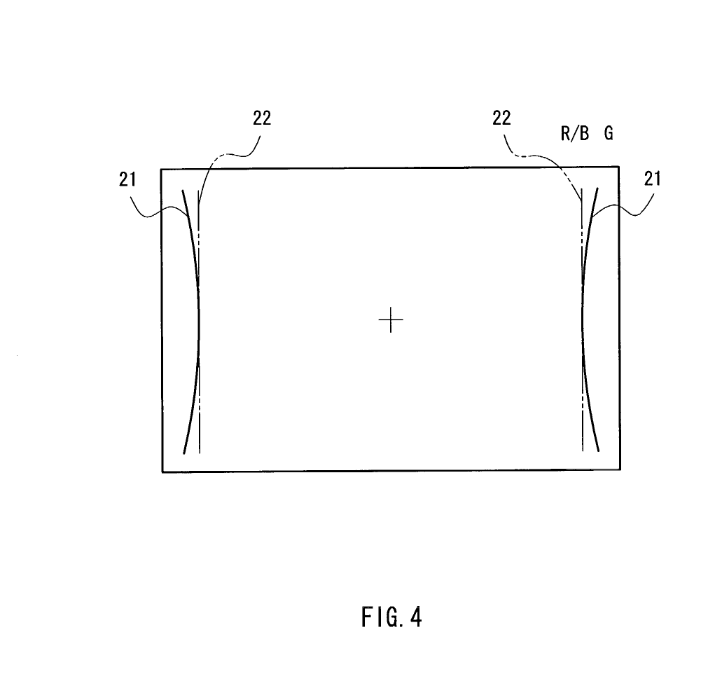

Here, FIG. 4 is a view illustrating an HGB pattern in which a green-light-emitting electron beam 21 and blue-light-emitting and red-light-emitting electron beams 22 fall on the same position in a right middle portion and a left middle portion of the screen, whereas at corners, the green-light-emitting electron beam 21 is deviated outward more with increasing proximity to the top or bottom, as compared with the blue-light-emitting and red-light-emitting electron beams 22. Such an HGB pattern appears when, for instance, an HCR is corrected, and it becomes more significant as the screen surface is flattened more.

The following will describe a principle of the correction of the HGB.

It is considered that an HGB is caused when an electron beam is deflected toward the screen periphery near corners of a screen, since on such an occasion the control of a main pincushion magnetic field on a horizontal axis is attenuated. Therefore, to correct such an HGB, the main pincushion magnetic field may be reinforced when the electron beam is deflected to the screen periphery near corners.

The reinforcement of the main pincushion magnetic field means that a barrel magnetic field in the screen periphery near corners is reinforced in a diagonal magnetic field at the same time. Thus, basically, it is considered that the effect obtained is more significant with increasing proximity to the screen periphery near corners, that is, as the electron beam is in closer proximity to the horizontal deflection coil.

The following will describe effects of the cathode-ray tube device according to the embodiment of the present invention, with regard to the electron-gun-side region 3, the middle region 4, and the screen-side region 5, respectively, in the stated order.

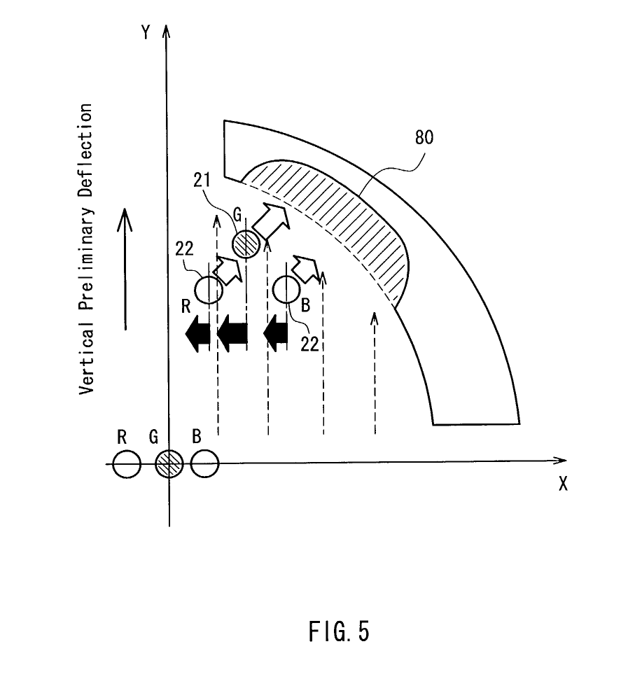

First, the effect on the electron-gun-side region 3 is described. FIG. 5 is a cross-sectional view taken in a direction perpendicular to the tube axis, which schematically illustrates a beam arrangement and a horizontal deflection magnetic field in the electron-gun-side region 3. As shown in FIG. 5, the horizontal defection magnetic field in the electron-gun-side region 3 is relatively uniform, and the preliminary vertical deflection is affected strongly.

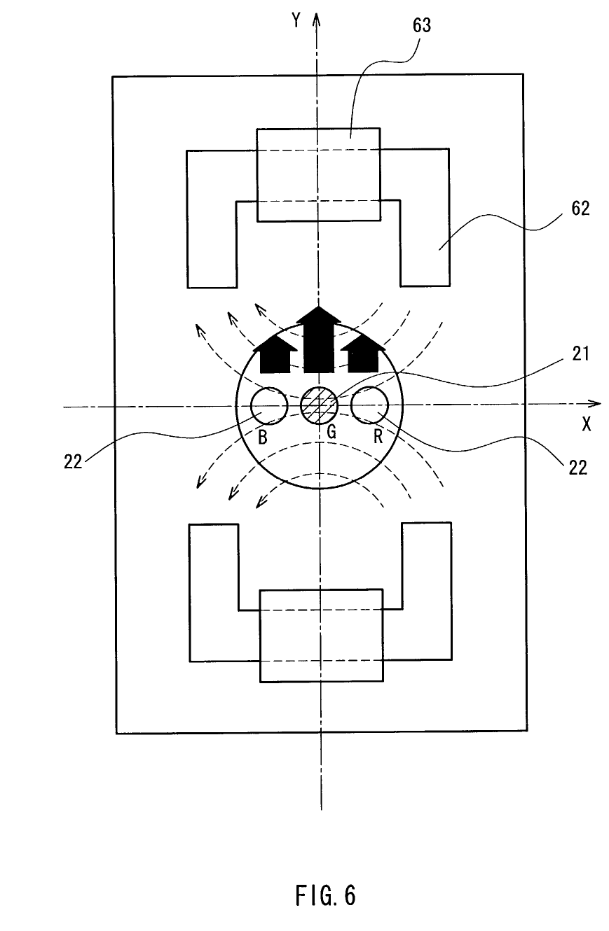

Here, the preliminary vertical deflection is a function for correcting a coma by providing U-shaped silicon steel sheets 62 so that their N and S poles are vertically symmetrical, as shown in FIG. 6, on an electron-gun-side rear end 61 of the deflection yoke shown in FIG. 1 and passing a vertical deflection current through vertical auxiliary correcting coils 63. In other words, by pulling the green-light-emitting electron beam 21 at the electron-gun-side rear end 61 upward in the y direction as compared with the blue-light-emitting and red-light-emitting electron beams 22, the coma can be corrected.

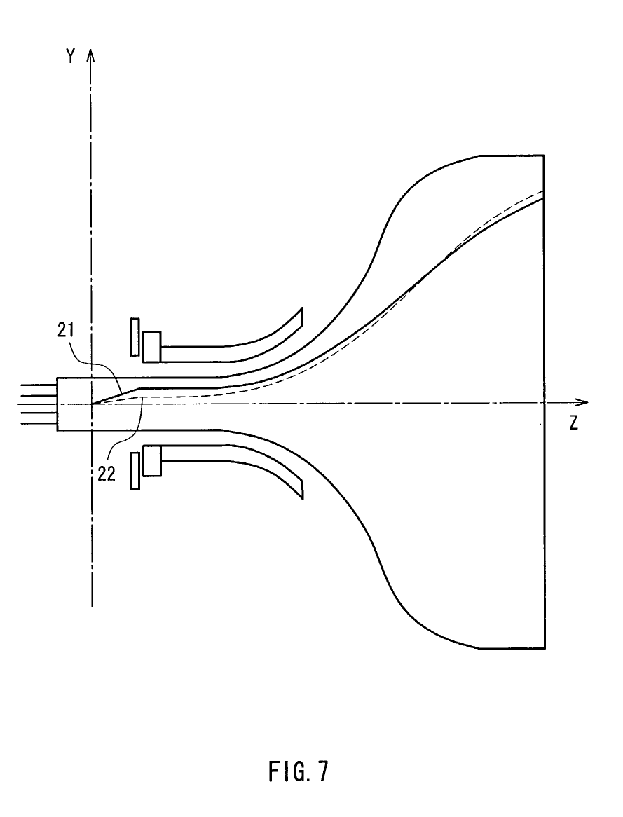

However, the correction effect is more significant with increasing proximity to the electron gun, and as seen in FIG. 7, the deviation in the y direction of a path (solid line) along which the green-light-emitting electron beam 21 emitted in the tube axial direction (in a positive z direction) decreases as the beam travels from the electron-gun-side region 3 to the screen-side region 5, as compared with a path (broken line) of the blue-light-emitting and red-light-emitting electron beams 22.

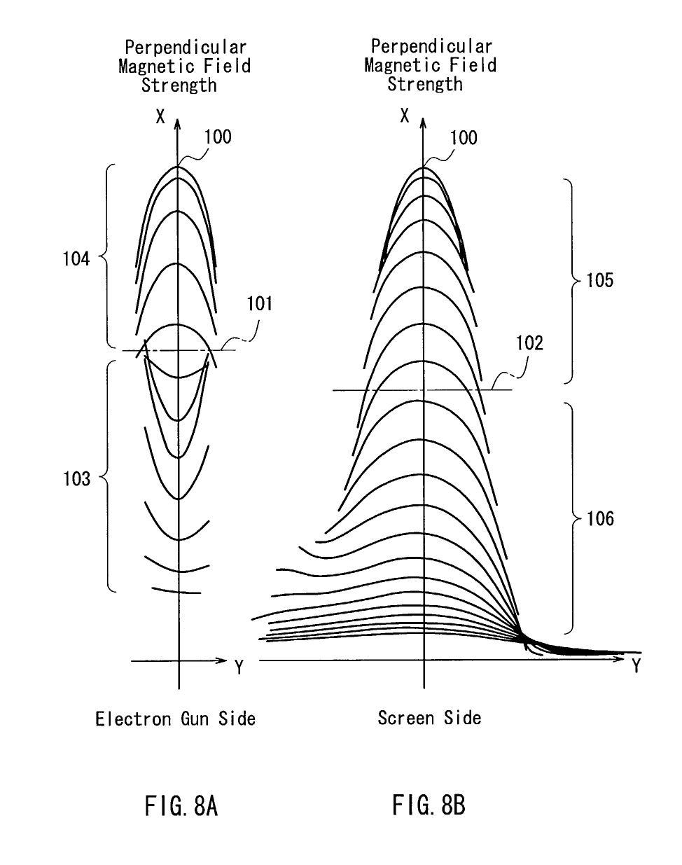

FIG. 8A and 8B are graphs in which a perpendicular magnetic field distribution is plotted with the y direction as a horizontal axis and a perpendicular magnetic field strength as a vertical axis. Here, the perpendicular magnetic field strength was measured at positions resolved in 5 mm increments in the z direction from a position at which the perpendicular magnetic field strength was maximized. It should be noted that FIG. 8A illustrates the measurement result at the positions on the electron gun side, while FIG. 8B illustrates the measurement results at the position on the screen side.

In FIGS. 8A and 8B, 100 indicates a position at which the perpendicular magnetic field had the greatest strength, 101 indicates an intermediate point between the position at which the perpendicular magnetic field had the greatest strength and an end position of the horizontal deflection coil on the electron gun side, and 102 indicates an intermediate point between the position at which the perpendicular magnetic field had the greatest strength and an end position of the horizontal deflection coil on the screen side. In the FIGS. 8A and 8B, a region from the end of the horizontal deflection coil on the electron gun side to the intermediate point 101 is referred to as an electron-gun-side region 103, a region from the intermediate point 101 to the intermediate point 102 is referred to as a middle region 104 on the screen side, and a region from the intermediate point 102 to an end position of the horizontal deflection coil on the screen side is referred to as a screen-side region 105.

As shown in FIGS. 8A and 8B, a pattern of a pincushion magnetic field is exhibited in the electron-gun-side region 103, and a pattern of a barrel magnetic field is exhibited in the middle region 104. In the screen-side region 105, a pattern of a weak barrel magnetic field is exhibited.

Therefore, it can be seen that not only at the rear end 61 of the electron-gun-side region but also in a larger region extending from the electron-gun-side region 3 to the screen-side region 5, a force reverse to the perpendicular magnetic field as shown in FIG. 6 works continuously. Besides, regarding the strengths of forces applied to the electron beams, the strength of a force applied to the green-light-emitting electron beam 21 is greater than that applied to the blue-light-emitting and red-light-emitting electron beams 22.

This illustrates that the green-light-emitting electron beam 21 is pulled upward in the y direction (in a direction of decreasing proximity to the tube axis) in the electron-gun-side region 3 as shown in FIG. 7, and as the beam is traveling from the electron gun side to the screen side, the beam is pulled in a direction of increasing proximity to the tube axis (an absolute value of a y coordinate thereof decreases).

Moreover, according to FIG. 5, substantially no horizontal pincushion magnetic field is applied in the electron-gun-side region 3, while the region is subjected to only the preliminary vertical deflection. Therefore, the position of the green-light-emitting electron beam 21 in the vertical direction (y direction) is slightly on an upper side as compared with the position of the red-light-emitting and blue-light-emitting beams 22.

By utilizing such an effect of the preliminary vertical deflection, the HGB correction is executed. More specifically, assuming that a region 80 in FIG. 5 (hatched portion in the drawing) were present, a force applied to the green-light-emitting electron beam 21 is greater in a positive horizontal direction than each of forces applied to the red-light-emitting and blue-light-emitting electron beams 22, as indicated by void arrows in FIG. 5.

However, in the present embodiment, the region 80 is removed substantially, that is, a recess is formed therein. Therefore, the forces applied to the electron beams by the preliminary vertical deflection are as indicated by solid arrows directed in a negative horizontal direction, and this indicates that the force applied to the green-light-emitting electron beam 21 is smaller in the positive horizontal direction as compared with each of those applied to the red-light-emitting and blue-light-emitting electron beams 22. This effect increases with increasing proximity of the electron beam path to the region 80.

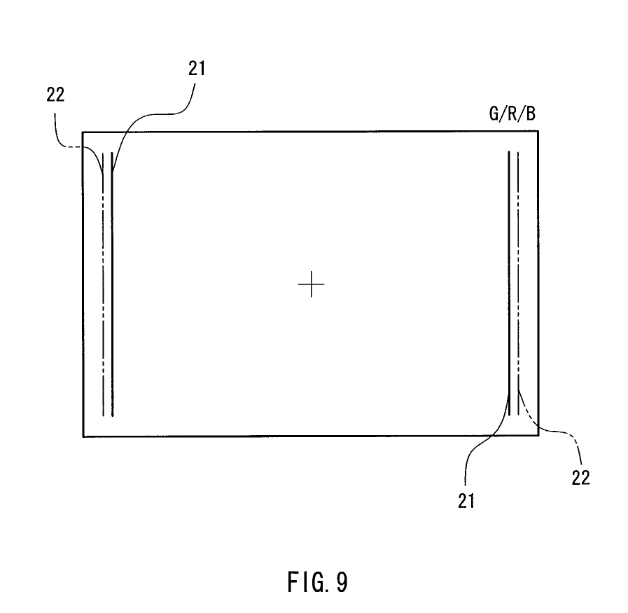

According to what is described above, in the electron-gun-side region 3, the provision of a recess as described above ensures the correction of the HGB pattern shown in FIG. 4 into that shown in FIG. 9.

It should be noted that the HGB pattern correcting means is not limited to the means of removing the region 80, that is, the means of forming a recess. The correction may be achieved by a configuration in which a cavity is formed in the housing, or a configuration in which an insulating substance is inserted into the cavity. Further, the wire density of the first portion 31 can be made smaller than the wire density of the second portion 32 by, instead of the formation of a recess, a configuration in which the number of turns of a wire in the first portion 31 shown in FIG. 3 is smaller than the number of turns of a wire in the second portion 32, that is, a configuration in which the density of turns of the former is made smaller than that of the latter. Thus, any of these configurations makes it possible to achieve the above-described effect.

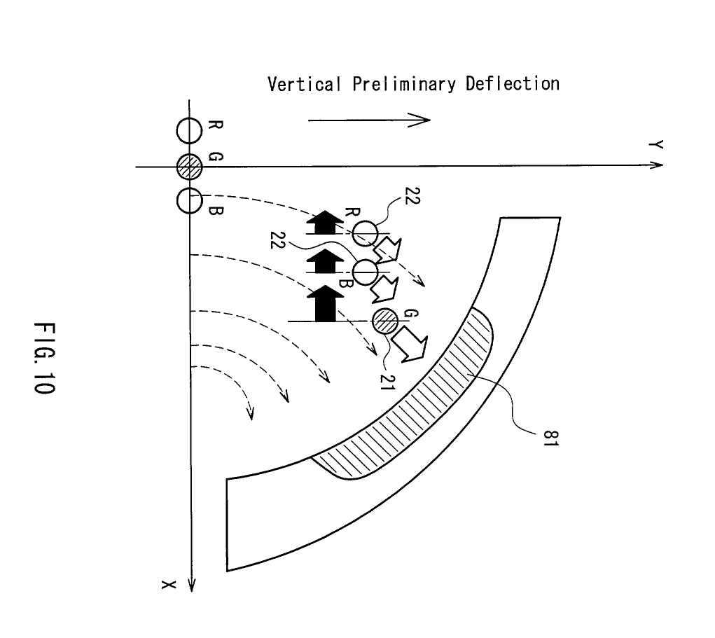

Next, the effect in the middle region 4 is described. FIG. 10 is a cross-sectional view taken in a direction perpendicular to the tube axis, which schematically illustrates a beam arrangement and a horizontal deflection magnetic field in the middle region 4.

In the middle region 4, the horizontal deflection magnetic field is a weak pincushion magnetic field, and a preliminary vertical deflection effect achieved therein is slightly weaker than that in the electron-gun-side region 3. Here, since a horizontal deflection pincushion magnetic field is applied strongly, the position of the green-light-emitting electron beam 21 in the horizontal direction (x direction) is outer with respect to the positions of the blue-light-emitting and red-light-emitting electron beams 22, as shown in FIG. 10. Furthermore, since the beams are subjected to the weak preliminary vertical deflection, the position of the green-light-emitting electron beam 21 in the vertical direction (y direction) is slightly above the positions of the blue-light-emitting and red-light-emitting electron beams 22.

Furthermore, the HGB correction can be executed in the same manner as that in the case of the electron-gun-side region 3. More specifically, assuming that a region 81 shown in FIG. 10 (hatched region in the drawing) were present, a force applied to the green-light-emitting electron beam 21 is greater in a positive horizontal direction than each of forces applied to the blue-light-emitting and red-light-emitting electron beams 22, as indicated by void arrows in FIG. 10.

However, in the present embodiment, the region 81 is removed, that is, a recess is formed therein. The forces applied to the three electron beams are as indicated by solid arrows directed in a negative horizontal direction, and this indicates that the force applied to the green-light-emitting electron beam 21 is smaller in the positive horizontal direction as compared with each of those applied to the red-light-emitting and blue-light-emitting electron beams 22. This effect increases with increasing proximity of the electron beam path to the region 81.

According to what is described above, in the middle region 4 as well, the formation of a recess in a portion of the horizontal deflection coil ensures the correction of the HGB pattern shown in FIG. 4 into the HGB pattern shown in FIG. 9.

It should be noted that the HGB pattern correcting means is not limited to the means of removing the region 81, that is, the means of forming a recess. The correction may be achieved by a configuration in which a cavity is formed in the housing, or a configuration in which an insulating substance is inserted into the cavity. Further, the wire density of the first portion 31 can be made smaller than the wire density of the second portion 32 by, instead of the formation of a recess, a configuration in which the number of turns of a wire in the first portion 31 shown in FIG. 3 is smaller than the number of turns of a wire in the second portion 32, that is, a configuration in which the density of turns of the former is made smaller than that of the latter. Thus, any of these configurations makes it possible to achieve the above-described effect.

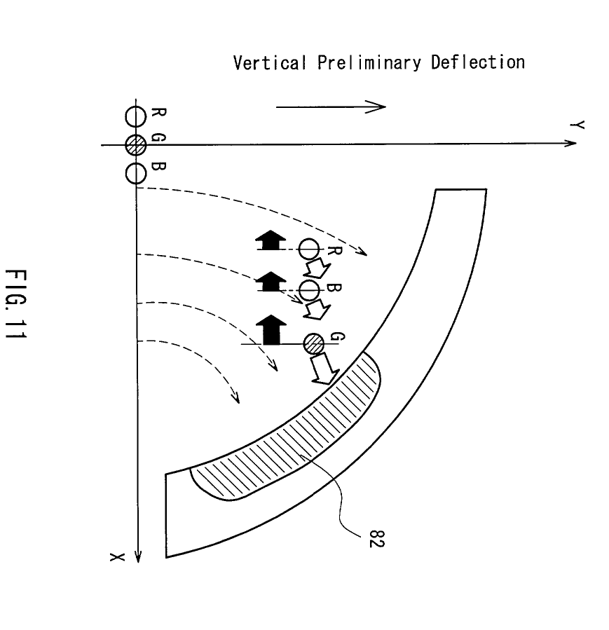

Next, the effect in the screen-side region 5 is described. FIG. 11 is a cross-sectional view taken in a direction perpendicular to the tube axis, which schematically illustrates a beam arrangement and a horizontal deflection magnetic field in the screen-side region 5. In the screen-side region 5, the horizontal deflection magnetic field is a pincushion magnetic field, and a preliminary vertical deflection effect achieved therein is significantly weaker than that in the electron-gun-side region 3.

Here, since a horizontal deflection pincushion magnetic field is applied, the position of the green-light-emitting electron beam 21 in the horizontal direction (x direction) is considerably outer with respect to the positions of the blue-light-emitting and red-light-emitting electron beams 22, as shown in FIG. 11. Furthermore, since the beams are subjected to the preliminary vertical deflection that is significantly weak here, the position of the green-light-emitting electron beam 21 in the vertical direction (y direction) is slightly upper with respect to the positions of the blue-light-emitting and red-light-emitting electron beams 22.

Furthermore, the HGB correction can be executed in the same manner as that in the case of the electron-gun-side region 3. More specifically, assuming that a region 82 shown in FIG. 11 (hatched region in the drawing) were present, a force applied to the green-light-emitting electron beam 21 is greater in a positive horizontal direction than each of forces applied to the red-light-emitting and blue-light-emitting electron beams 22, as indicated by void arrows shown in FIG. 11.

However, in the present embodiment, the region 82 is removed, that is, a recess is formed therein. Therefore, the forces applied to the three electron beams are as indicated by solid arrows directed in a negative horizontal direction, and this indicates that the force applied to the green-light-emitting electron beam 21 is smaller in the positive horizontal direction as compared with each of those applied to the red-light-emitting and blue-light-emitting electron beams 22. This effect increases with increasing proximity of the electron beam path to the region 82.

According to what is described above, in the screen-side region 5, the formation of a recess in a portion of the horizontal deflection coil ensures the correction of the HGB pattern shown in FIG. 4 into the HGB pattern shown in FIG. 9.

It should be noted that the HGB pattern correcting means is not limited to the means of removing the region 82, that is, the means of forming a recess. The correction may be achieved by a configuration in which a cavity is formed in the housing, or a configuration in which an insulating substance is inserted into the cavity. Further, the wire density of the first portion 31 can be made smaller than the wire density of the second portion 32 by, instead of the formation of a recess, a configuration in which the number of turns of a wire in the first portion 31 shown in FIG. 3 is smaller than the number of turns of a wire in the second portion 32, that is, a configuration in which the density of turns of the former is made smaller than that of the latter. Thus, any of these configurations makes it possible to achieve the above-described effect.

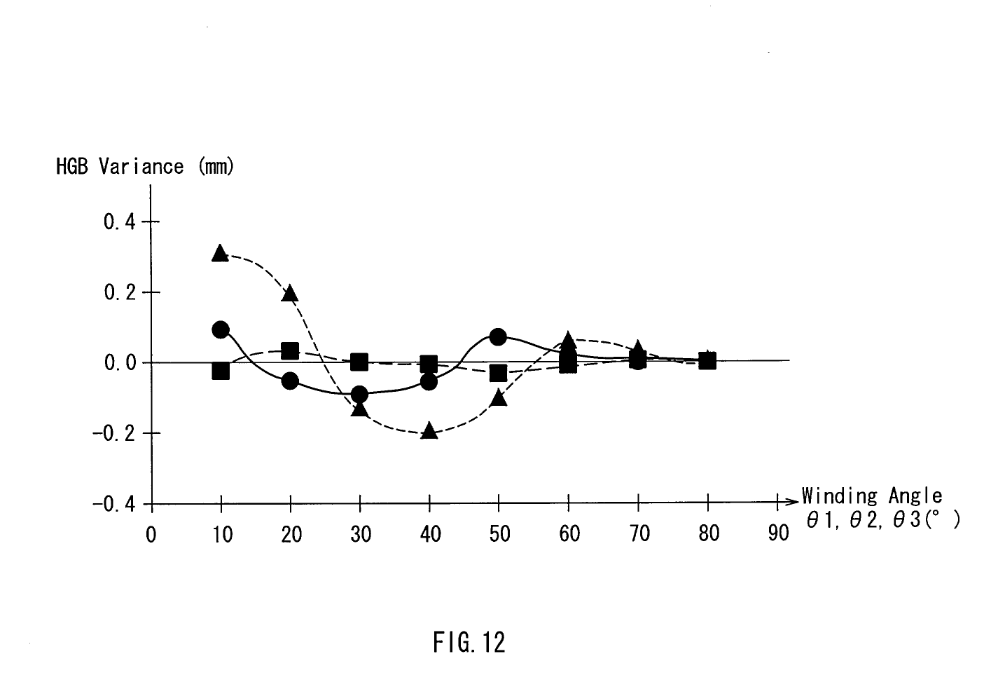

The following will describe the results of an experiment about the relationships of the winding angles θ1, θ2, and θ3 of a recess formed in the electron-gun-side region 3, the middle region 4, and the screen-side region 5 with HGB variances, while referring to FIG. 12. In FIG. 12, an HGB variance (mm) is used to enter the vertical axis, while the winding angles θ1, θ2, and θ3 (°) are used to enter the horizontal axis. It should be noted that in the experiment the recess was formed in only one of the electron-gun-side region 3, the middle region 4, and the screen-side region 5.

In the graph, □ indicates an HGB variance in the electron-gun-side region 3, Δ indicates an HGB variance in the middle region 4, and ∘ indicates an HGB variance in the screen region 5.

In FIG. 12, a minus (−) value of the HGB variance is considered to indicate that the HGB pattern was corrected effectively. Therefore, it is clear that the preferred range of the winding angle is 35°≦θ1≦65° in the electron-gun-side region 3, 25°≦θ2≦55° in the middle region 4, and 15°≦θ3≦45° in the screen-side region 5.

As described above, since the influence of the preliminary vertical deflection magnetic field varies from the electron-gun-side region 3 to the screen-side region 5, it is necessary to set the winding angle for each of the regions. More specifically, since the influence of the preliminary vertical deflection magnetic field decreases from the electron-gun-side region 3 to the screen-side region 5, it is considered to be preferable that the winding angle decreases toward to the screen-side region 5. Therefore, the winding angles θ1, θ2, and θ3 desirably satisfy the relationship expressed by the following formula 3:

θ1≧θ2≧θ3

It should be noted that in a portion with a low wire space factor of not more than 50%, that is, a portion around a pin hole and a coil end portion, it is impossible to specify a variation of a density of wires, and the effect of the deflection magnetic field of wires (coil) with respect to electron beams is not applied generally. In other words, copper wires are not arrayed uniformly in a cross section of the housing but are present in disorder. Here, the wire space factor is defined as a rate that the coil wires actually occupy in a region where the deflection coil is present substantially.

In such a state, it is difficult also to control the same with a magnetic field, and it is still difficult to predict the influence of a magnetic field disambiguously. Therefore, in the three-dimensional-shaped portion according to the present embodiment, the wire space factor thereof preferably is not less than 50%.

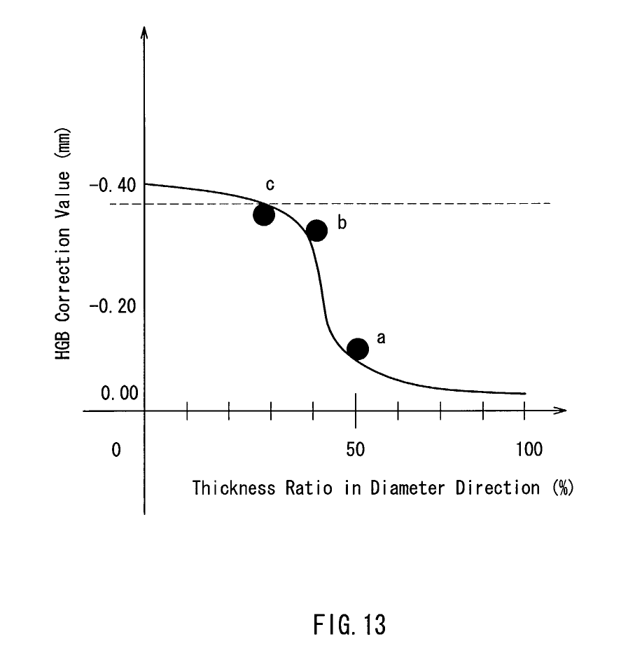

Furthermore, FIG. 13 is a view illustrating the relationship between a thickness ratio taken in a substantial diameter direction (thickness ratio on a cross section perpendicular to the tube axis with respect to the maximum thickness) and a value of correction of a misconvergence HGB. It should be noted that in FIG. 13, a, b, and c indicate values of HGB correction when the thickness ratio is 50%, when the thickness ratio is 40%, and when the thickness ratio is 28%, respectively, in the case where the recess is provided with the winding angle being set to be approximately 35° in the middle region 4.

As is clear from FIG. 13, the HGB correction significantly improves when the thickness ratio is 40 to 50%. Therefore, it is considered that a greater effect is achieved when the thickness ratio is set to be less than 40%.

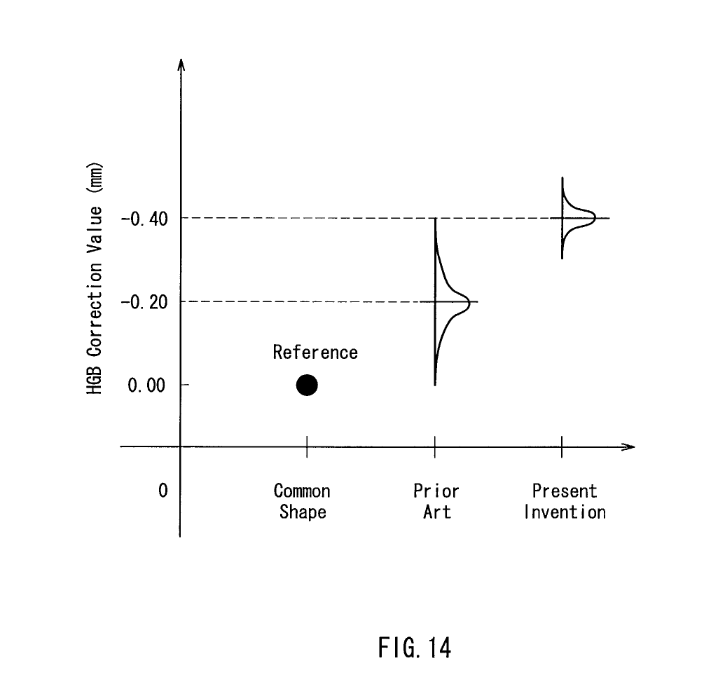

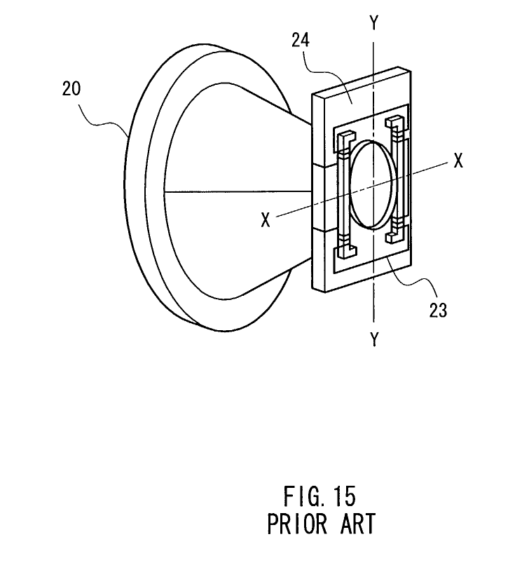

FIG. 14 illustrates the effect of the HGB correction achieved in the case where the horizontal deflection coil having the three-dimensional-shape portion as described above is used in the cathode-ray tube device according to the present embodiment. In FIG. 14, “Common Shape” indicates experimental data in the case of a standard coil shape, and “Prior Art” indicates experimental data in the case where additional correcting coils (sub coils) 23 and 24 disclosed in JP 3053841B, shown in FIG. 15, were used. It should be noted that values of the HGB correction in FIG. 14 were detected from left and right portions of a screen of the cathode-ray tube device as shown in FIG. 9.

As clear from FIG. 14, in the case where a coil having the three-dimensional-shape portion according to the present embodiment was used, the HGB correction was improved as compared with the prior art by −0.20 (mm). The reason why such an improved effect was achieved is considered as follows: the prior art is presumed to have a limit concerning the structure or the current flow since the HGB correction is carried out in a subsequent step using a correcting current, whereas in the present embodiment, the HGB correction is carried out with respect to HGB generating factors, with causes of the HGB taken into consideration. Therefore, in the present embodiment, the effect is exhibited more significantly.

Furthermore, as shown in FIG. 14, the HGB correction is achieved using a singularity of a coil. Therefore, the degree of variation of the same is approximately 50% of that of the prior art, which is at a level of the variation in the case of a single coil.

As described above, with the cathode-ray tube device according to the present invention, it is possible to significantly correct the value of the HGB appearing in the vicinity of each corner of a screen, thereby ensuring the stable continuous production of coils and the production of high-definition deflection yokes. Besides, the variation of the production yield of the deflection yoke is attributed to a variation due to a coil. Thus, the variation is reduced by approximately 50% or more, which facilitates the dynamic convergence adjustment, and makes it possible to obtain a cathode-ray tube device having an excellent convergence characteristic with an excellent ITC adjustment efficiency.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A cathode-ray tube device comprising:
a cathode-ray tube having a glass panel, and a glass funnel behind the glass panel, which is connected to the glass panel;
an electron gun provided in a rear part of the cathode-ray tube; and
a deflection yoke including a horizontal deflection coil arranged on a circumferential surface of the rear part of the cathode-ray tube, a vertical deflection coil provided on an outer side of the horizontal deflection coil, and a ferrite core,
wherein the horizontal deflection coil is formed by winding conductive wires,
a wire density of the conductive wires in a first portion of the horizontal deflection coil, which is defined in a predetermined angle range centering on a winding angle with respect to a horizontal direction as 0° on a cross section perpendicular to a tube axis, is smaller than a wire density of the conductive wires in a second portion of the horizontal deflection coil that is a portion of the horizontal deflection coil other than the first portion, and
the winding angle is set to be θ1 with respect to a horizontal direction as 0° in a first region extending to an end position of the horizontal deflection coil on an electron gun side from a first intermediate point between the end position on the electron gun side and a position at which a horizontal magnetic field has a maximum strength, the winding angle is set to be θ2 with respect to a horizontal direction as 0° in a second region extending from the first intermediate point to a second intermediate point between an end position of the horizontal deflection coil on a screen side and the position at which a horizontal magnetic field has a maximum strength, and the winding angle is set to be θ3 with respect to a horizontal direction as 0° in a third region extending from the second intermediate point to the end position of the horizontal deflection coil on the screen side, with θ1, θ2, and θ3 satisfying:
θ1≧θ2≧θ3

2. The cathode-ray tube device according to claim 1, wherein the predetermined angle range is an angle range of ±2° centering on the winding angle.

3. The cathode-ray tube device according to claim 1, wherein a recess is formed in the first portion of the horizontal deflection coil.

4. The cathode-ray tube device according to claim 3, wherein the first portion of the horizontal deflection coil has a thickness of less than 40% of a maximum thickness of the horizontal deflection coil.

5. The cathode-ray tube device according to claim 1, wherein the winding angle θ1 satisfies 35°≦θ1≦65°.

6. The cathode-ray tube device according to claim 1, wherein the winding angle θ2 satisfies 25°≦θ2≦55°.

7. The cathode-ray tube device according to claim 1, wherein the winding angle θ3 satisfies 15°≦θ3≦45°.

8. A cathode-ray tube device comprising:
a cathode-ray tube having a glass panel, and a glass funnel behind the glass panel, which is connected to the glass panel;
an electron gun provided in a rear part of the cathode-ray tube; and
a deflection yoke including a horizontal deflection coil arranged on a circumferential surface of the rear part of the cathode-ray tube, a vertical deflection coil provided on an outer side of the horizontal deflection coil, and a ferrite core,
wherein the horizontal deflection coil is formed by winding conductive wires, and
the horizontal deflection coil includes a first region extending to an end position of the horizontal deflection coil on an electron gun side from a first intermediate point between the end position on the electron gun side and a position at which a horizontal magnetic field has a maximum strength, a second region extending from the first intermediate point to a second intermediate point between an end position of the horizontal deflection coil on a screen side and the position at which a horizontal magnetic field has a maximum strength, and a third region extending from the second intermediate point to the end position of the horizontal deflection coil on the screen side,
wherein at least two of the first, second, and third regions include a first portion defined in a predetermined angle range centering on a winding angle with respect to a horizontal direction as 0° on a cross section of the horizontal deflection coil perpendicular to a tube axis,
a winding angle of the first portion in one of the two regions on the electron gun side is greater than a winding angle of the first portion in the other region on the screen side, and
a wire density of the conductive wires in the first portion is smaller than a wire density of the conductive wires in a second portion, the second portion being a portion of the horizontal deflection coil other than the first portion.

9. The cathode-ray tube device according to claim 8, wherein the predetermined angle range is an angle range of ±2° centering on the winding angle.

10. The cathode-ray tube device according to claim 8, wherein a recess is formed in the first portion of the horizontal deflection coil.

11. The cathode-ray tube device according to claim 10, wherein the first portion of the horizontal deflection coil has a thickness of less than 40% of a maximum thickness of the horizontal deflection coil.

12. A cathode-ray tube device comprising:
a cathode-ray tube having a glass panel, and a glass funnel behind the glass panel, which is connected to the glass panel;
an electron gun provided in a rear part of the cathode-ray tube; and
a deflection yoke including a horizontal deflection coil arranged on a circumferential surface of the rear part of the cathode-ray tube, a vertical deflection coil provided on an outer side of the horizontal deflection coil, and a ferrite core,
wherein the horizontal deflection coil is formed by winding conductive wires, and
the horizontal deflection coil includes a first region of the horizontal deflection coil that extends to an end position of the horizontal deflection coil on an electron gun side from an intermediate point between the end position on the electron gun side and a position at which a horizontal magnetic field has a maximum strength,
wherein in the first region, a wire density of the conductive wires in a first portion of the horizontal deflection coil, defined in a predetermined angle range centering on a winding angle θ1 with respect to a horizontal direction as 0° on a cross section perpendicular to a tube axis, is smaller than a wire density of the conductive wires in a second portion of the horizontal deflection coil, the second portion being a portion of the horizontal deflection coil other than the first portion.

13. The cathode-ray tube device according to claim 12, wherein the predetermined angle range is an angle range of ±2° centering on the winding angle.

14. The cathode-ray tube device according to claim 12, wherein a recess is formed in the first portion of the horizontal deflection coil.

15. The cathode-ray tube device according to claim 14, wherein the first portion of the horizontal deflection coil has a thickness of less than 40% of a maximum thickness of the horizontal deflection coil.

16. The cathode-ray tube device according to claim 12, wherein the winding angle θ1 satisfies 35°≦θ1≦65°.

17. A cathode-ray tube device comprising:
a cathode-ray tube having a glass panel, and a glass funnel behind the glass panel, which is connected to the glass panel;
an electron gun provided in a rear part of the cathode-ray tube; and
a deflection yoke including a horizontal deflection coil arranged on a circumferential surface of the rear part of the cathode-ray tube, a vertical deflection coil provided on an outer side of the horizontal deflection coil, and a ferrite core,
wherein the horizontal deflection coil is formed by winding conductive wires, and
the horizontal deflection coil includes a second region extending from a first intermediate point between an end position of the horizontal deflection coil on an electron gun side and a position at which a horizontal magnetic field has a maximum strength to a second intermediate point between an end position of the horizontal deflection coil on a screen side and the position at which a horizontal magnetic field has a maximum strength,
wherein in the second region, a wire density of the conductive wires in a first portion of the horizontal deflection coil, which is defined in a predetermined angle range centering on a winding angle θ2 with respect to a horizontal direction as 0° on a cross section perpendicular to a tube axis, is smaller than a wire density of the conductive wires in a second portion of the horizontal deflection coil, the second portion being a portion of the horizontal deflection coil other than the first portion.

18. The cathode-ray tube device according to claim 17, wherein the predetermined angle range is an angle range of ±2° centering on the winding angle.

19. The cathode-ray tube device according to claim 17, wherein a recess is formed in the first portion of the horizontal deflection coil.

20. The cathode-ray tube device according to claim 19, wherein the first portion of the horizontal deflection coil has a thickness of less than 40% of a maximum thickness of the horizontal deflection coil.

21. The cathode-ray tube device according to claim 17, wherein the winding angle θ2 satisfies 25°≦θ2≦55°.

22. A cathode-ray tube device comprising:
a cathode-ray tube having a glass panel, and a glass funnel behind the glass panel, which is connected to the glass panel;
an electron gun provided in a rear part of the cathode-ray tube; and
a deflection yoke including a horizontal deflection coil arranged on a circumferential surface of the rear part of the cathode-ray tube, a vertical deflection coil provided on an outer side of the horizontal deflection coil, and a ferrite core,
wherein the horizontal deflection coil is formed by winding conductive wires, and
the horizontal deflection coil includes a third region extending from an intermediate point between an end position of the horizontal deflection coil on a screen side and a position at which a horizontal magnetic field has a maximum strength to the end position of the horizontal deflection coil on the screen side,
wherein in the third region, a wire density of the conductive wires in a first portion of the horizontal deflection coil, which is defined in a predetermined angle range centering on a winding angle θ3 with respect to a horizontal direction as 0° on a cross section perpendicular to a tube axis, is smaller than a wire density of the conductive wires in a second portion of the horizontal deflection coil, the second portion being a portion of the horizontal deflection coil other than the first portion.

23. The cathode-ray tube device according to claim 22, wherein the predetermined angle range is an angle range of ±2° centering on the winding angle.

24. The cathode-ray tube device according to claim 22, wherein a recess is formed in the first portion of the horizontal deflection coil.

25. The cathode-ray tube device according to claim 24, wherein the first portion of the horizontal deflection coil has a thickness of less than 40% of a maximum thickness of the horizontal deflection coil.

26. The cathode-ray tube device according to claim 22, wherein the winding angle θ3 satisfies 15°≦θ3≦45°.
